(19) United States
(12) Patent Application Publication
(10) Pub. No.: US 2012/0241268 A1
(43) Pub. Date: Sep. 27, 2012

(54) ARRANGEMENT FOR THE VIBRATION ISOLATION OF A PAY LOAD

(75) Inventors: Dick Antonius Hendrikus Laro, Breda (NL); Jan van Eijk, Eindhoven (NL); Yim-Bun Patrick Kwan, Aalen (DE)

(73) Assignee: CARL ZEISS SMT GMBH, Oberkochen (DE)

(21) Appl. No.: 13/425,935

(22) Filed: Mar. 21, 2012

Related U.S. Application Data
(60) Provisional application No. 61/466,981, filed on Mar. 24, 2011.

(30) Foreign Application Priority Data
Mar. 24, 2011 (DE) 10 2011 006 024.3

(51) Int. Cl. F16F 7/10; F16F 7/104

(52) U.S. Cl. 188/379; 188/378

(57) ABSTRACT

The disclosure relates to arrangements and methods for vibration isolation of a payload from a body. An arrangement for vibration isolation of a payload from a body having vibrations includes a sensor for measuring vibrations, and an actuator for generating a compensation force on the payload, at least on the basis of the measurement of the sensor. At least one balancing mass is arranged in the reaction path of a reaction force associated with the compensation force, and the sensor is mounted on the body.

### CROSS-REFERENCE TO RELATED APPLICATIONS

This application claims priority under 35 U.S.C. §119(e)(1) to U.S. Provisional Application No. 61/466,981 filed Mar. 24, 2011. This application also benefit under 35 U.S.C. §119 to German Application No. 10 2011 006 024.3, filed Mar. 24, 2011. The contents of both of these applications are hereby incorporated by reference in its entirety.

### FIELD

The disclosure relates to arrangements for vibration isolation of a payload from a body having vibrations. The disclosure can be implemented, for example, for vibration isolation of optical elements of, e.g., a microlithographic projection exposure apparatus, such as a projection exposure apparatus designed for operation in the EUV, but is not restricted to such applications. Rather, the disclosure can advantageously be realized in all arrangements in which the transmission of vibrations of a body to a payload is intended to be prevented or at least minimized.

### BACKGROUND

Diverse approaches are known for mechanically isolating a payload from the surroundings in such a way that the transmission of external vibrations to the payload is suppressed as much as possible.

U.S. Pat. No. 5,823,307 discloses an active vibration isolating system and a method for actively isolating a payload from vibration in a vibrating body, wherein the payload is coupled to actuators of variable length, and wherein the shear forces occurring at the actuators are decoupled by varying the length of respectively another actuator.

Typical conventional approaches for realizing a vibration isolation system for the isolation of a payload from a vibrating platform are explained below with reference to the schematic illustrations in FIGS. 5a-c.

In accordance with FIG. 5a, for the purpose of isolating a payload 510 from a vibrating base or platform 505, a vibration isolation is realized in the form of a spring system 530. Proceeding from this construction, in the arrangements in accordance with FIGS. 5b-c an active vibration isolation is effected by introducing a counterforce which at least partly suppresses or compensates for the disturbance brought about by the vibration. For this purpose, the arrangements illustrated in FIGS. 5b and 5c respectively have an acceleration sensor 540 fixed to the platform 505, wherein the suppression or compensation force suitable for suppressing the vibration of the platform 505 is calculated on the basis of the measurement of the acceleration sensor 540 and the transmission function of the spring system 530. An actuator serves for generating the suppression or compensation force, which actuator can be configured, by way of example, in accordance with FIG. 5b as an active mounting mechanically coupled to the spring system 530 and having a piezo-actuator, for example, in the form of a vibration damper 520, or in accordance with FIG. 5c as an actuator 560 acting on the payload 510.

The known approachs explained above with reference to FIGS. 5b and 5c have in common that a respective reaction path exists between the acceleration sensor 540 and the active mounting 520 (in FIG. 5b) and the actuator 560 (in FIG. 5c), since all of these components are mounted directly on the platform 505 and every force exerted on the respective payload by an actuator, on the basis of the action/reaction Newtonian principle is accompanied by a reaction force of equal magnitude acting in the opposite direction. Consequently, the reaction force corresponding to the suppression or compensation force reaches the acceleration sensor 540, which can lead to instability problems and impairment of the vibration isolation and the performance of the system.

### SUMMARY

The disclosure provides an arrangement for vibration isolation of a payload which enables the influence of external vibrations to be suppressed in an improved fashion. One exemplary application of the disclosure is, in particular, the vibration isolation of optical components in a microlithographic projection exposure apparatus. In a projection exposure apparatus designed for EUV, i.e., for electromagnetic radiation having a wavelength of less than 15 nm, mirrors are used as optical components for the imaging process due to general lack of availability of materials which are transmissive to these wavelengths of radiation.

One desirable goal in practice is to maintain the positions of the mirrors (as “payload”) with respect to one another even upon the occurrence of external vibrations relative to an outer platform in the form of a non-vibration-isolated frame (“vibrating body”).

According to an aspect of the disclosure, an arrangement for vibration isolation of a payload from a body having vibrations includes:
a sensor for measuring vibrations; and
an actuator for generating a compensation force on the payload at least on the basis of the measurement of the sensor;
wherein at least one balancing mass is arranged in the reaction path of a reaction force associated with the compensation force, and
wherein the sensor is mounted on the body.

The present disclosure is based on the concept, in particular, in a vibration isolation system including a sensor serving for measuring vibrations that occur, and including an actuator serving to compensate for the vibrations, of decoupling the reaction path between sensor and actuator by using a balancing mass. According to the disclosure, vibration suppression or compensation can be realized in the form of a feedforward control, wherein the input signal is in each case provided by a vibration-measuring sensor (and, if appropriate, on the basis of the transmission function of an isolating system present in the form of a spring system, for example), and wherein a reaction force leading toward the sensor is at least partly eliminated via the balancing mass.

In accordance with the above aspect of the disclosure the sensor is mounted on the vibrating body. Such an arrangement has the advantage that the vibrations occurring at the vibrating body are significantly greater than the vibrations still occurring at the payload in the arrangement according to the disclosure and a vibration measurement can thus be effected with greater accuracy.

The disclosure in particular considers that, according to conventional approaches, the vibration level is measured on the payload, and a disturbance rejection is performed based on that sensor signal. However, in a lithographic system the respective sensor signals are very low because a high degree of filtering is desired. This results in a limitation of the ultimate performance of the vibration isolation system by the sensor noise. By measuring the disturbance at its source, as done in the above concept of the present disclosure, a higher signal to noise ratio can be achieved to overcome the above mentioned problems.

The balancing mass can, in particular, be mechanically coupled directly to the actuator. Furthermore, the balancing mass is preferably mounted via a guide. The payload is preferably mechanically coupled to the body having vibrations via an isolating system (e.g. in the form of a spring system).

The use of a balancing mass in an arrangement for vibration isolation differs from conventional applications of balancing masses in connection with the active positioning of mirrors in a projection exposure apparatus in particular as far as the use conditions and desired features with regard to the suitable natural frequencies and/or spring stiffnesses in the mechanical linking are concerned, as is explained below:

The stiffness k₁ of the guide of the balancing mass used in accordance with the disclosure forms, together with the mass m₁ of the balancing mass, a mass-spring system having a natural frequency

$${f}_{1} = \frac{1}{2 π} \cdot \sqrt{\frac{{k}_{1}}{{m}_{1}}} \qquad ( 1 )$$

For effective suppression of the reaction force, this frequency should be significantly less (preferably at least by a factor of 5, in particular at least by a factor of 10) than the working frequency or isolation frequency f₂ of the isolating system

$${f}_{2} = \frac{1}{2 π} \cdot \sqrt{\frac{{k}_{2}}{{m}_{2}}} \qquad ( 2 )$$

where k₂ designates the stiffness of the isolating system and m₂ designates the mass of the payload.

If the working frequency or isolation frequency f₂ of the isolating system is, for example, 5 Hz (typical values can be, for example, in the range of 0.2 Hz to 5 Hz), then for the natural frequency f₁ of the mass-spring system composed of guide of the balancing mass and mass of the balancing mass, a value of 1 Hz or 0.5 Hz (given an isolation frequency of f₂=0.5 Hz even a value of f₁=0.1 Hz or f₁=0.05 Hz) should not be exceeded, in order still to ensure effective suppression of the reaction force by the balancing mass used according to the disclosure, such that the balancing mass is in actual fact mounted substantially without friction or restoring force. For this purpose, in those degrees of freedom or directions in which no actuation is effected, the guide or the mechanical suspension of the balancing mass can have an air bearing or be configured as some other suitable bearing with a flexible mounting element.

In accordance with one embodiment, the guide can be arranged between the payload and the balancing mass, such that the balancing mass is suspended on the payload itself. In further embodiments, the guide can also be arranged between the balancing mass and the body having vibrations.

In accordance with one embodiment of the disclosure, the arrangement further includes a drift correction device that limits a relative movement between the balancing mass and the payload. This is advantageous primarily with regard to a—as described above—preferred virtually frictionless suspension of the balancing mass for example via an air bearing. Such a drift correction device can be configured, for example, for passive drift regulation in the form of a spring having low stiffness or for active drift regulation with a control loop with an actuating drive.

In accordance with one embodiment, the actuator used for vibration suppression is designed as a contactless actuator, wherein the actuator can have, for example, at least one Lorentz motor.

The actuator can be mechanically linked between the payload and the balancing mass. By way of example, the actuator can have at least one piezo-actuator operated in the force mode.

According to a further aspect of the disclosure, an arrangement for the vibration isolation of a payload from a body having vibrations includes:
a sensor for measuring vibrations; and
an actuator for generating a compensation force on the payload at least on the basis of the measurement of the sensor;
wherein at least one balancing mass is arranged in the reaction path of a reaction force associated with the compensation force; and
wherein the actuator is mechanically linked directly between the balancing mass and the payload.

In accordance with one embodiment, the payload is mechanically coupled to the body having vibrations via an isolating system.

In accordance with one embodiment, the line of action of the actuator crosses the line of action of the isolating system at common location at the payload.

According to the further aspect, the disclosure considers that a drawback in conventional approaches according to FIG. 5b, wherein the disturbance is measured at the location of the source 505 and a force is generated there as well, is that the force can excite the dynamics of the floor, which will be measured again by the sensor. This can lead to performance degradation and instability of the control loop. In contrast to this, according to an aspect of the disclosure, by generating the force at the payload and using the balance mass both the forward and reaction path forces are filtered. The forward path is filtered by the vibration isolation system, and the reaction path is filetered by the balance mass. As a consequence, instability problems caused by the actuation forces can be avoided.

Further configurations of the disclosure can be gathered from the description and the dependent claims.

### BRIEF DESCRIPTION OF THE DRAWINGS

The disclosure is explained in greater detail below on the basis of exemplary embodiments illustrated in the accompanying figures, in which:

FIGS. 1-4 show schematic illustrations for elucidating different embodiments of the disclosure;

FIGS. 5a-c show schematic illustrations for elucidating conventional approaches for vibration suppression; and

FIG. 6 shows a schematic illustration of a microlithographic projection exposure apparatus designed for EUV as a possible exemplary application of the disclosure.

### DETAILED DESCRIPTION

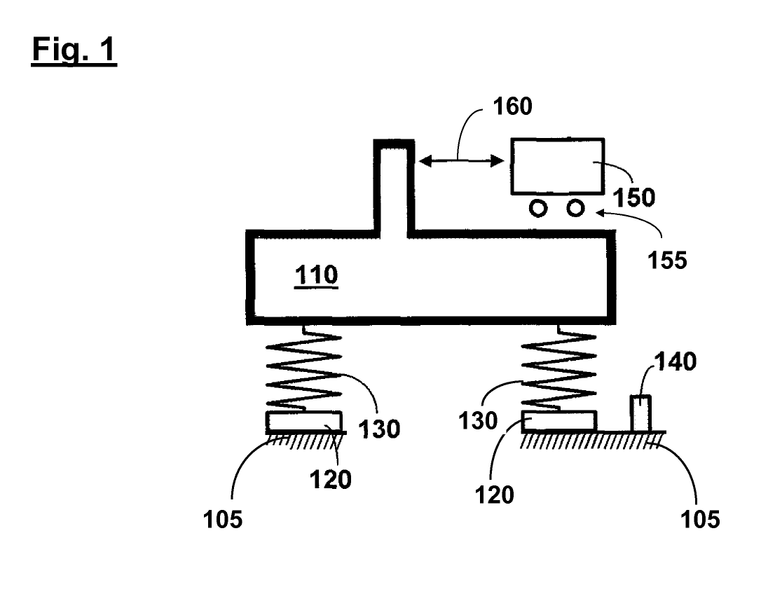

FIG. 1 shows a basic schematic diagram for elucidating the concept underlying the disclosure, on the basis of a first embodiment.

The arrangement illustrated in FIG. 1 has a payload 110 (which can be e.g. a mirror in an EUV projection exposure apparatus), which is fixed to a body having vibrations in the form of a platform 105 via an isolating system 130 in the form of a spring system. The isolating system 130 serves for the dynamic isolation of the payload 110 from the platform 105 and preferably has a very low spring stiffness, corresponding to a filter or isolation frequency in the range of from 0.2 Hz to 5 Hz. Piezo-actuators for linking the isolating system 130 to the platform 105 are designated by 120, which are optional and can also be omitted in further embodiments.

The disclosure is not restricted to the example of a mirror as payload. Thus, the payload can also be any other structure to be isolated with regard to vibrations, for example a carrier structure which is to be isolated from vibrations of a platform and on which one or a plurality of (optical or other) elements are mounted.

The isolating system 130, for further suppression of the vibrations occurring at the platform 105, is firstly—in this respect still in a manner known per se—combined with a sensor 140 measuring the vibrations of the platform 105 in the form of an acceleration sensor, in order to actively suppress the vibrations through suitable driving of an actuator. In this case, a suppression or compensation force which is suitable for suppressing the vibration of the platform 105 and is to be exerted by the actuator can be calculated on the basis of the acceleration measured by the sensor 140 and the transmission function of the isolating system 130.

An actuator 160, symbolized by a double-headed arrow, serves for generating the suppression or compensation force, wherein the double-headed arrow simultaneously indicates the direction of the force exerted on the payload 110 by the actuator 160 and likewise the direction of the reaction force associated with the force on the basis of the Newtonian action/reaction principle. The actuator 160 can be embodied, for example, as a contactless actuator, in particular as a Lorentz actuator.

The arrangement from FIG. 1 has a balancing mass 150, which is mechanically coupled directly to the actuator 160. 155 designates a guide (schematically illustrated) for the balancing mass 150. The balancing mass 150 is mechanically suspended on the guide 155. The guide 155 can be configured, e.g., in the form of a guide provided with air bearings or in the form of a spring joint.

The guide enables movement of the balancing mass 150 in at least one degree of freedom, namely in that direction or in that degree of freedom in which the actuation is effected. In embodiments of the disclosure, the balancing mass can be mounted in all six degrees of freedom with a low stiffness in order to obtain a decoupling of the reaction force in all six degrees of freedom. This can take account of the circumstance that an actuation always also brings about parasitic forces in those degrees of freedom in which no actuation is effected.

In the exemplary application of the vibration isolation of a mirror in an EUV projection exposure apparatus, in the absence of the balancing mass 150, the actuator 160 (e.g. with the coil of a Lorentz actuator) would be mounted on the non-vibration-isolated frame of the projection exposure apparatus (corresponding to the platform 105). Typically, the magnet of the Lorentz actuator is mounted on the mirror side and the coil is mounted on the supporting structure side. Consequently, the reaction force associated with the force exerted on the mirror as payload 110 by the actuator 160 would likewise come through to the non-vibration-isolated frame and thus find its way to the sensor 140. Since the force to be generated by the actuator 160 is calculated, in particular, on the basis of the sensor signal (and on the basis of the transmission function of the isolating system 130), the reaction force contains an undesired component in antiphase, which would bring about an instability in the control of the actuator. Owing to the presence of the balancing mass 150 in the arrangement according to the disclosure, it is now possible to prevent the reaction force from coming through, or at least to reduce that.

In order, in the arrangement from FIG. 1, to ensure an effective suppression of the reaction force by the balancing mass 150, the natural frequency of the mass-spring system formed from the guide 155 and the balancing mass 150 should be chosen suitably. In particular, on account of the low value of the isolation frequency of the isolating system 130, the natural frequency of the mass-spring system formed from the guide 155 and the balancing mass 150 should also have a very low value, preferably a value of a maximum of one tenth of the isolation frequency of the isolating system 130. What is thereby achieved is that the abovementioned reaction force acts as desired on the balancing mass 150 rather than being transmitted to the platform 105, for instance, via the isolating system 130 or via the sensor 140 and the force-regulating control loop of the actuator 160. In the example of an isolation frequency of the isolating system 130 of 0.5 Hz, therefore, the natural frequency of the guide or mounting 155 is preferably not more than 0.05 Hz. The guide or mounting 155 of the balancing mass 150 is thus in actual fact a guide which is substantially without friction or restoring force and can have, in particular, air bearings, and, depending on the use conditions, can also be configured in any other suitable manner.

A completely frictionless guide of the balancing mass 150 would have the consequence of the balancing mass 150 bringing about an ideal suppression of the reaction force for all frequencies. Suitable values of the suppression factor obtained in practice by the balancing mass 150 can be, for example, approximately 100.

The—as explained above preferably virtually frictionless—guide 155 is preferably used in combination with a drift correction device in order to limit a relative movement between balancing mass 150 and payload 110 and, in particular, to prevent uncontrolled drifting away of the balancing mass 150. Such a drift correction device can be configured for example in the form of a spring having low stiffness for passive drift regulation or as a control loop with an actuating drive for active drift regulation.

In accordance with FIG. 1, the guide 155 is arranged directly between the balancing mass 150, on the one hand, and the payload 110, on the other hand, such that guide 155, payload 110 and actuator 150 form a self-contained system which (apart from possible connections e.g. to piezo-actuators) is completely separated from the platform 105 or the non-vibration-isolated frame. Such a configuration is particularly advantageous in particular in the case of use under vacuum conditions, such as in an EUV projection exposure apparatus, for instance, since the platform 105 or the non-vibration-isolated frame can then be situated in the region of the ambient atmosphere, whereas the payload 110 or the mirror is arranged in a vacuum and a transition between ambient atmosphere and vacuum takes place only in the region of the isolating system 130.

Under the vacuum conditions mentioned above, the virtually frictionless guide 155 to be provided according to the disclosure for the balancing mass 150 can also be realized, instead of the use of air bearings (which can likewise also be used under vacuum conditions, in principle), via a magnetic mounting or via a suitable isolating system e.g. with the use of leafsprings.

The disclosure is not restricted to specific embodiments of the actuator 160. Rather, the disclosure can be realized in conjunction with any suitable force actuators for actuation in one or a plurality of (e.g. six) degrees of freedom. In one example, for actuation in six degrees of freedom, provision can also be made of an arrangement composed of six individual actuators (e.g. Lorentz actuators) respectively designed for actuation in one degree of freedom. Furthermore, the actuator or actuators can be mechanically linked to the payload 110 or the mirror in any desired configuration that is suitable depending on the geometry of the payload. Possible configurations are e.g. the mechanical linking in two bipod configurations via in each case three mounting locations, the individual linking of six actuators via a separate mounting location in each case, etc.

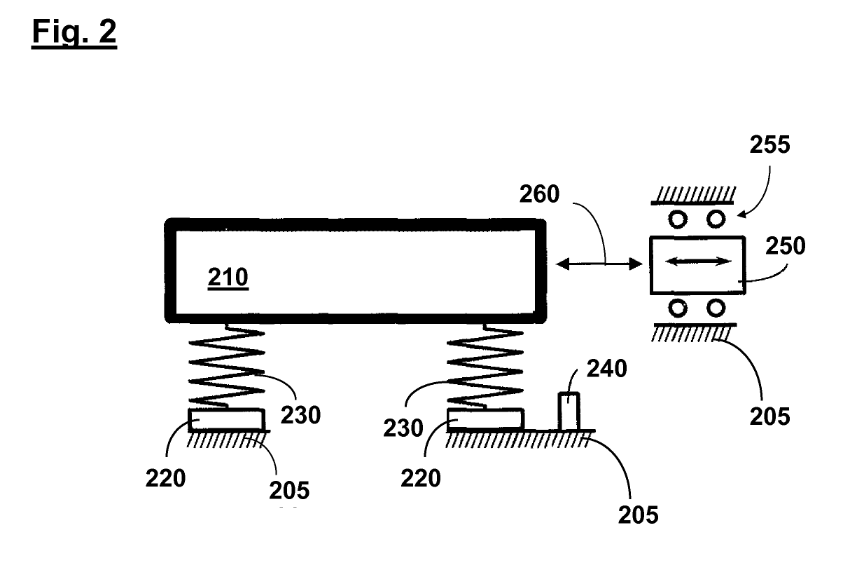

FIG. 2 shows a further embodiment of an arrangement according to the disclosure, wherein components analogously or substantially functionally identical to FIG. 1 are designated by corresponding reference numerals increased by “100”. The arrangement from FIG. 2 differs from that from FIG. 1 in that the guide 255 is not arranged between payload 210 and balancing mass 250, but rather between the balancing mass 250 and the body having vibrations or the platform 205, that is to say that the balancing mass 250 is mechanically suspended or mounted on the platform 205.

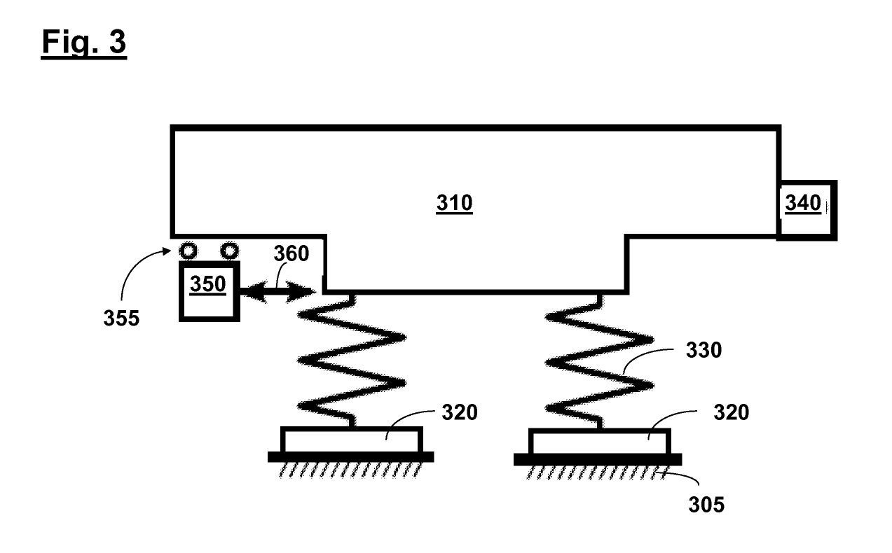

FIG. 3 shows a further embodiment of an arrangement according to the disclosure, wherein components analogous or substantially functionally identical to FIG. 1 are designated by corresponding reference numerals increased by “200”. The arrangement from FIG. 3 differs from that from FIGS. 1 and 2 in that the sensor 340 is placed on the payload 310. Furthermore, the actuator 360 is mechanically linked directly between the balancing mass 350 and the payload 310. Furthermore, the actuator 360 is placed in a position where the disturbance from the body 305 enters the payload 310.

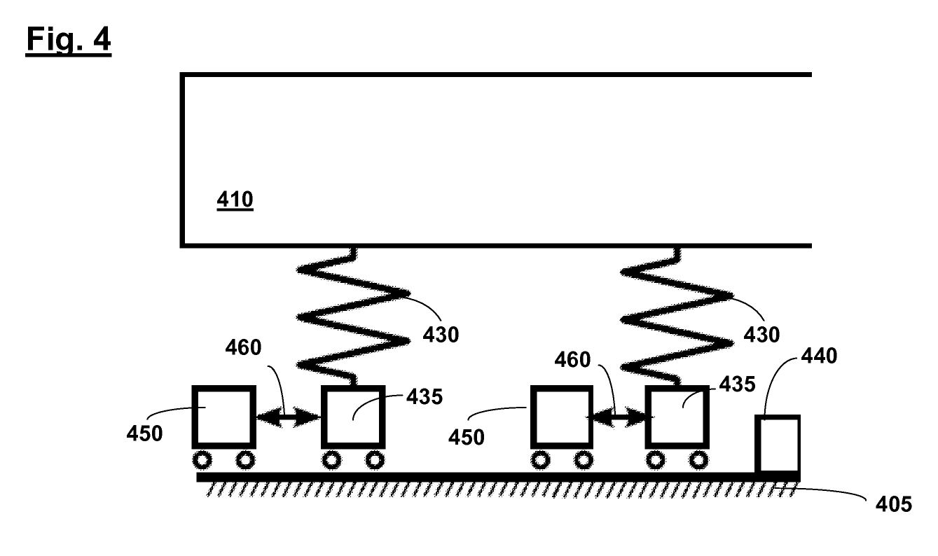

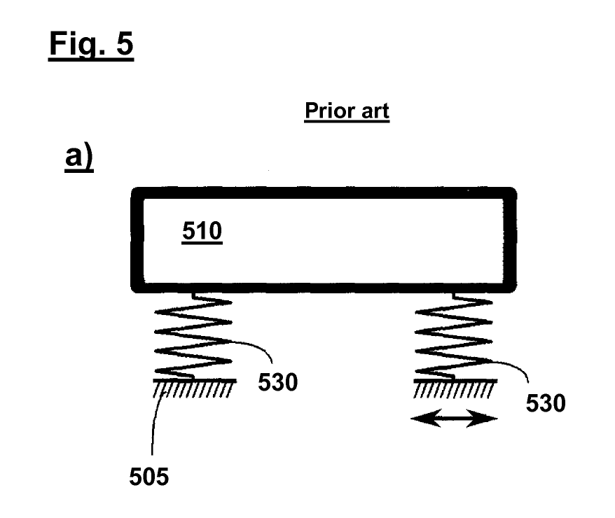

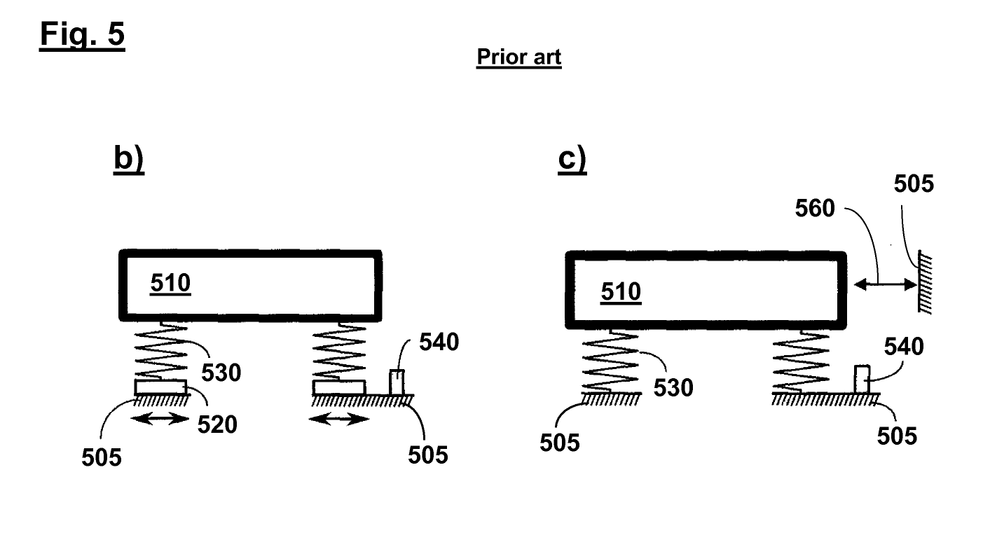

FIG. 4 shows a further embodiment of an arrangement according to the disclosure, wherein components analogous or substantially functionally identical to FIG. 1 are designated by corresponding reference numerals increased by “300”. The arrangement from FIG. 4 proceeds from the conventional arrangement from FIG. 5b, wherein account is taken of the circumstance that in this arrangement the reaction force of the vibration damper 520 acts on the platform 505 in an undamped fashion and is therefore measured at the sensor 540, which can in turn lead to an instability in the control of the vibration damper 520.

In order to overcome this problem, in the arrangement from FIG. 4, the reaction path of the compensation force exerted on the payload 410 via the isolating system 430 is decoupled by a balancing or reaction mass 450 being incorporated into the reaction path. On account of the decoupling of this reaction path, the actuator 460, which transmits the compensation force to the payload here via the isolating system 430, can be configured e.g. as a piezo-actuator or else as a Lorentz actuator and is mounted via a guide 455 analogously to the embodiments described above, can be regulated with a higher bandwidth, as a result of which it is possible to obtain a better vibration isolation over a larger frequency range. In FIG. 4, “435” designates an attachment piece merely used for mechanically linking the actuator 460 to the isolating system.

In the arrangement from FIG. 4, the disturbance generated by the vibration is reduced before it is transmitted at all to the isolating system 430. The concept explained with reference to FIG. 4 can be combined with the balancing mass coupled to the payload as described with reference to FIG. 1 or FIG. 2. In this case, however, with the sensor 440 still being mounted on the platform 405, the transmission function for calculating the force to be exerted by the actuator 460 includes the sensor signal of the sensor 440, the transmission function of a vibration damper possibly used and the transmission function of the isolating system 430.

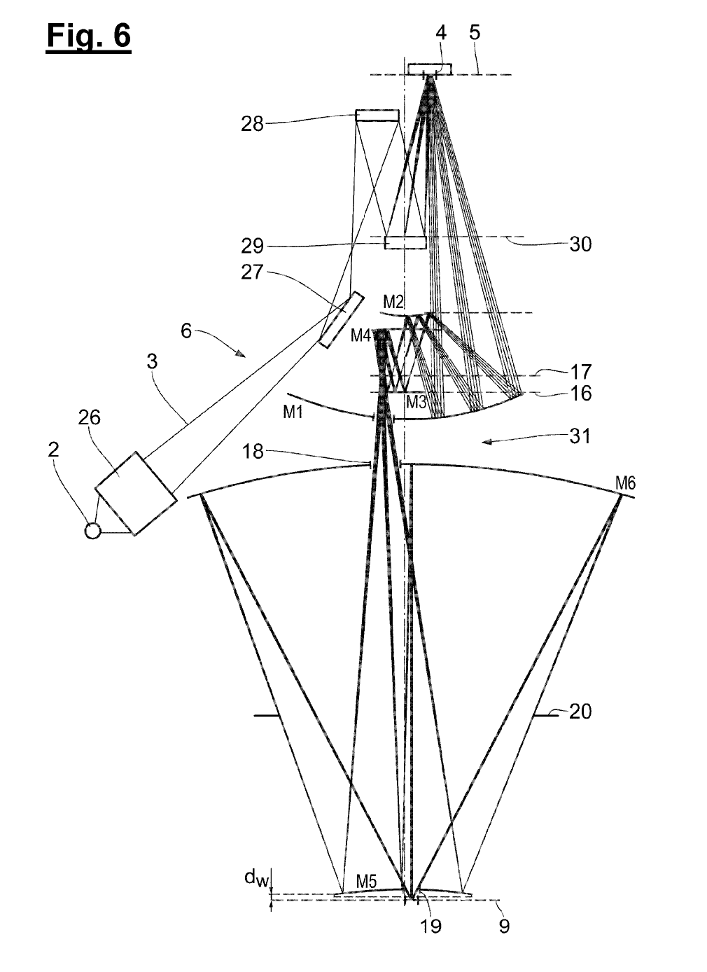

FIG. 6 shows in schematic illustration a lithographic projection exposure apparatus which is designed for operation in the EUV and in which the present disclosure can be realized by way of example.

The projection exposure apparatus in accordance with FIG. 6 has an illumination device 6 and a projection lens 31. The illumination device 6 includes, in the light propagation direction of the illumination light 3 emitted by a light source 2, a collector 26, a spectral filter 27, a field facet mirror 28 and a pupil facet mirror 29, from which the light impinges on an object field 4 arranged in an object plane 5. The light emerging from the object field 4 enters into the projection lens 31 with an entrance pupil 30. The projection lens 31 has an intermediate image plane 17, a first pupil plane 16 and a further pupil plane with a stop 20 arranged therein. The projection lens 31 includes a total of six mirrors M1-M6. M6 designates the last mirror relative to the optical beam path, the mirror having a passage hole 18. A beam emerging from the object field 4 or reticle arranged in the object plane passes, after reflection at the mirrors M1-M6 for the purpose of generating an image of the reticle structure to be imaged, onto a wafer arranged in the image plane 9.

Even though the disclosure has been described on the basis of specific embodiments, numerous variations and alternative embodiments are evident to the person skilled in the art, e.g. through combination and/or exchange of features of individual embodiments. Accordingly, it goes without saying for the person skilled in the art that such variations and alternative embodiments are concomitantly encompassed by the present disclosure, and the scope of the disclosure is restricted only within the meaning of the accompanying patent claims and the equivalents thereof.

1. An arrangement, comprising:
a payload;
a sensor configured to measure vibrations;
an actuator configured to generate a compensation force on the payload at least partially based on a measurement of the sensor;
a balancing mass arranged in a reaction path of a reaction force associated with the compensation force; and
a body capable of undergoing vibrations,
wherein the sensor is mounted on the body.

2. The arrangement of claim 1, wherein the balancing mass is directly mechanically coupled to the actuator.

3. The arrangement of claim 1, wherein the actuator is directly mechanically linked between the balancing mass and the payload.

4. The arrangement of claim 1, further comprising an isolating system which mechanically couples the payload to the body.

5. The arrangement of claim 4, wherein the actuator is mechanically linked between the balancing mass and the isolating system.

6. The arrangement of claim 25, further comprising an isolating system which mechanically couples the payload to the body, wherein a line of action of the actuator crosses a line of action of the isolating system at a common location at the payload.

7. The arrangement of claim 1, further comprising a guide, wherein the balancing mass is mounted via the guide.

8. The arrangement of claim 7, wherein the guide is between the payload and the balancing mass.

9. The arrangement of claim 7, wherein the guide is between the balancing mass and the body.

10. The arrangement of claim 7, further comprising an isolating system which mechanically couples the payload to the body, wherein a spring-mass system defined by a stiffness of the guide and the balancing mass has a natural frequency which is at least five times less than an isolation frequency of the isolating system.

11. The arrangement of claim 7, further comprising an isolating system which mechanically couples the payload to the body, wherein a spring-mass system defined by a stiffness of the guide and the balancing mass has a natural frequency of not more than 0.5 Hz.

12. The arrangement of claim 7, wherein the guide comprises a substantially frictionless mounting.

13. The arrangement of claim 7, wherein the actuator is configured to enable an actuation in one degree of freedom, and the guide is configured to enable a movement of the balancing mass in at least in the one degree of freedom.

14. The arrangement of claim 1, further comprising a drift correction device configured to limit a relative movement between the balancing mass and the payload.

15. The arrangement of claim 14, wherein the drift correction device is regulatable to provide active drift correction of the balancing mass.

16. The arrangement of claim 1, further comprising an isolating system which mechanically couples the payload to the body, wherein the actuator is configured to generate the compensation force on the payload based on the measurement of the sensor and based on a transmission function of the isolating system.

17. The arrangement of claim 1, comprising:
six balancing masses;
six guides, each guide having a corresponding one of the six balancing masses, and each guide being configured to enable movement of its corresponding balancing mass in six degrees of freedom; and
six actuators, each actuator configured to actuate in one respective degree of freedom, and each actuator being assigned to a corresponding one of the six balancing masses.

18. The arrangement of claim 1, wherein the actuator is a contactless actuator.

19. The arrangement of claim 1, wherein the payload comprises an optical element.

20. The arrangement of claim 1, wherein the payload comprises a mirror.

21. An apparatus, comprising:
the arrangement of claim 1,
wherein the apparatus is a microlithographic projection exposure apparatus.

22. The apparatus of claim 21, wherein the apparatus is an EUV microlithographic projection exposure apparatus.

23. The apparatus of claim 21, wherein the payload comprises an optical element.

24. The apparatus of claim 21, wherein the payload comprises a mirror.

25. An arrangement, comprising:
a payload;
a sensor configured to measure vibrations;
an actuator configured to generate a compensation force on the payload at least partially based on a measurement of the sensor; and
a balancing mass in a reaction path of a reaction force associated with the compensation force,
wherein the actuator is directly mechanically linked between the balancing mass and the payload.

26. The arrangement of claim 25, further comprising:
a body capable of undergoing vibrations; and
an isolating system which mechanically couples the payload to the body.
